(19) United States
(12) Patent Application Publication
(10) Pub. No.: US 2013/0024253 A1
(43) Pub. Date: Jan. 24, 2013

(54) PAPER PRODUCT ROLL CONFIGURED FOR ADVERTISING AND METHOD OF USE

(71) Applicants: Jordan Silverman, Rye Brook, NY (US); Bryan Silverman, Rye Brook, NY (US)

(72) Inventors: Jordan Silverman, Rye Brook, NY (US); Bryan Silverman, Rye Brook, NY (US)

(21) Appl. No.: 13/493,224

(22) Filed: Jun. 11, 2012

Related U.S. Application Data
(60) Provisional application No. 61/572,488, filed on Jul. 18, 2011.

(51) Int. Cl. B42D 15/00; G06Q 30/02

(52) U.S. Cl. 705/14.4; 283/56

(57) ABSTRACT

A paper product roll configured for advertising. The paper product roll is toilet paper or paper towel imprinted with advertising, wherein the advertising comprises on-line coupon redemption capability, instant coupon redemption, and advertisement tracking capability. In one embodiment, the sheets of the paper product roll consist of a plurality of plys and the advertising is imprinted on the top most ply. In another embodiment, the paper product rolls will be comprised of advertising groups, each group consisting of a plurality of advertisements or coupons, and the groups are functionally attached in series.

### CROSS-REFERENCE TO RELATED APPLICATIONS

This application claims the priority benefit of U.S. Provisional Application 61/572,488 filed Jul. 18, 2011, which is herein incorporated by reference in its entirety.

### BACKGROUND OF THE INVENTION

Paper products for use in conveying information are discussed in the prior art. For example, U.S. Pat. No. 6,926,308 describes how “Information may be placed, through printing or embossing, on the toilet paper, paper towels and facial tissues.” U.S. Pat. No. 6,926,308 is herein incorporated by reference in its entirety.

### BRIEF SUMMARY OF THE INVENTION

The present disclosure provides a paper product roll configured for advertising, the paper product roll comprising: toilet paper or paper towel imprinted with advertising, wherein the advertising comprises on-line coupon redemption capability and advertisement tracking capability. In another embodiment, the coupons and advertisements do not have online redemption and are simply torn off and redeemed by hand.

The paper product roll is a cylindrical roll with paper, wherein the paper is discharged from the cylinder in a continuous sheet as it is unrolled. The continuous sheet can have perforations for ease of tearing. In one embodiment, the continuous sheet comprises one or more layers which are functionally bonded. In another embodiment, the paper product roll is a roll of toilet paper or a roll of paper towel. In one embodiment, the paper product roll is a set of tri-fold single sheets instead of a continuous roll.

In one embodiment, the advertising is imprinted upon the toilet paper or paper towel with soybean based ink. This embodiment enables a product, which is septic safe, environmentally friendly, and does not run. In another embodiment, other inks are used that enable the imprinted images to be in different colors.

Advertising which is imprinted upon the toilet paper or paper towel can be physically used as a coupon. A user could simply tear the advertisement from the roll and present it for redemption at a later time.

In one embodiment, advertisements are further grouped in a series of advertisements with the groups repeating on the roll.

In one embodiment, the advertising can incorporate coupons, which can be redeemed on-line via the internet or a third party application.

In another embodiment, the advertising can include Quick Response (QR) Codes to enable tracking and monitoring of advertising performance. Each advertisement will be accompanied with a corresponding coupon code or QR Code. For example one coupon may have code US6 and another may have US8. Downloads, scans, etc. may be tracked via a system or method designed to provide analytical usage information such as Google Analytics, QRedit Scanner, or the like.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is a perspective view of a roll of toilet paper.

FIG. 2 is a front view of advertising and coupons on toilet paper.

FIG. 3 is a perspective view of a roll of paper towels.

FIG. 4 is a front view of advertising and coupons on a paper towel sheet.

FIG. 5 is a side view of a tri-fold paper towel sheet.

FIG. 6 is a front view of advertising and coupons on a tri-fold paper towel sheet.

FIG. 7 is a block diagram of a typical computing environment used for implementing embodiments of the present disclosure.

FIG. 8 is a network diagram of a system, which can redeem coupon codes, QR codes, or the like.

FIG. 9 shows a method for redeeming a coupon code.

FIG. 10 shows a method for redeeming a QR code.

FIG. 11 shows a method for incorporating a third party application into the coupon redemption or instant redemption field.

FIG. 12 is a side view of a roll of toilet paper with the end sheet flared to show different plys.

### DETAILED DESCRIPTION OF THE INVENTION

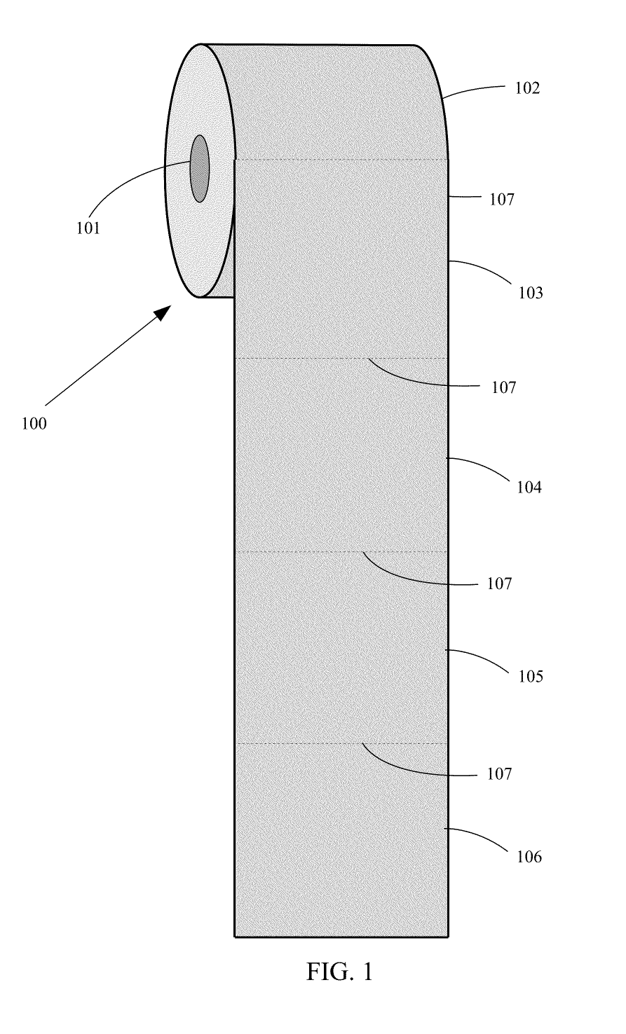

FIG. 1 is a perspective view of a roll of toilet paper. Shown is a roll of toilet paper 100, a cylindrical cardboard insert 101 on which the toilet paper 102 is rolled around; a first piece 103, a second piece 104, a third piece 105, a fourth piece 106, and so on. The pieces are sectioned from each other with perforations 107. In other embodiments, there are no perforations. Each of the squares is attached to not only another square, but in the end, also to the cylindrical cardboard insert 101. In one embodiment, this series will continue for approximately 500 sheets per roll (depending on size/length of roll).

While this FIG. 1 shows what advertising on a typical toilet paper roll would look like, advertisements can be printed on all sizes and shapes of toilet paper. For example, toilet paper could also be supplied in individual sheets instead of rolls or on jumbo toilet paper rolls ranging from 1000 feet to 4000 feet.

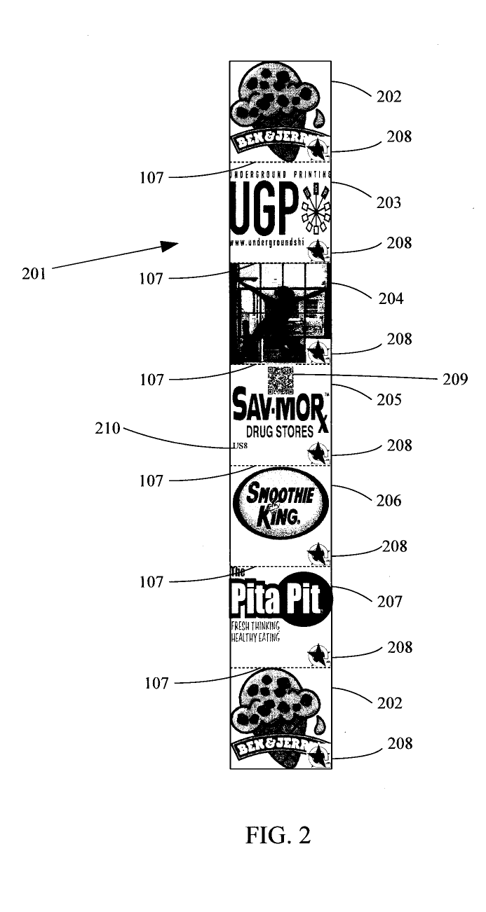

FIG. 2 is a front view of advertisements and coupons on toilet paper. In FIG. 2, there is shown a series of sheets of toilet paper 201 each having various advertisements and/or coupons imprinted on them. The advertisements and/or coupons can be imprinted on the sheets in soybean-based ink or the like. The advertisements and/or coupons are grouped, each group consisting of six consecutive sheets (in this embodiment) with each advertisement and/or coupon repeated once per group. In other embodiments, groups consist of two or more sheets. FIG. 2 shows the first sheet 202 in a group, a second sheet 203, a third sheet 204, a fourth sheet 205, a fifth sheet 206, and a sixth sheet 207. Then, the next group begins with first sheet 202. The sheets are sectioned from each other with perforations 107. In the bottom right corner of each ad is a logo 208 representing Star Toilet Paper. The fourth sheet 205, includes a QR code 209 and a coupon code 210.

The construction details of the embodiment shown in FIG. 2 are that the series of sheets 201 may be constructed of one, two, three, or four ply toilet paper, but regardless the advertisements and/or coupons will be printed on the top toilet paper ply. In another embodiment, the advertisements and/or coupons may be printed on the back of the toilet paper or a second ply to maximize the image space and user friendliness of the product.

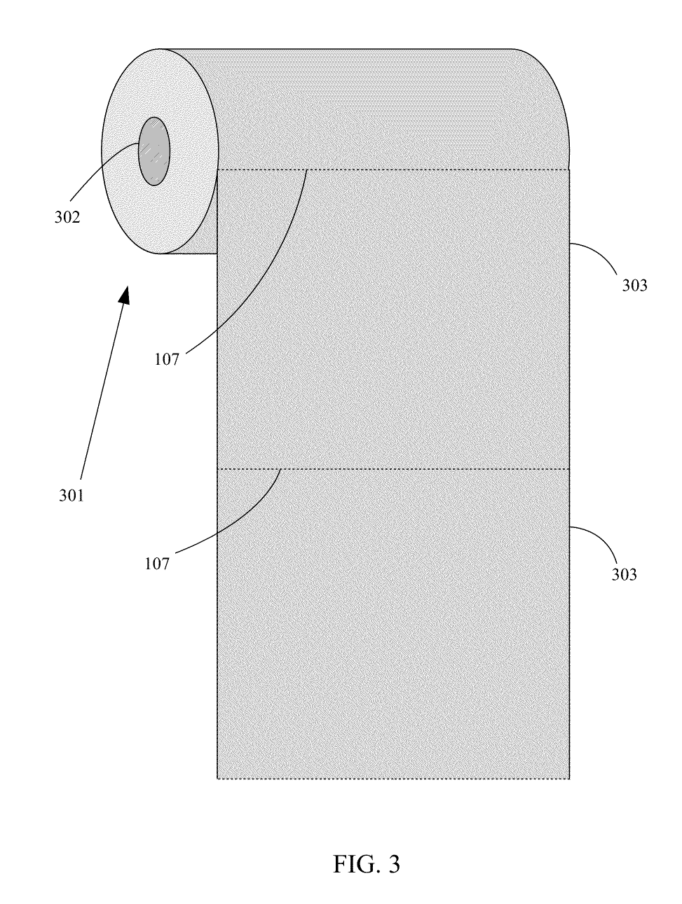

FIG. 3 is a perspective view of a roll of paper towels. In one embodiment, a jumbo-sized roll of paper towels is approximately 8″×950′. The average bathroom user uses one or two paper towel sheets per bathroom visit. In other embodiments, one or more advertisements can be imprinted per sheet. It will allow for the person to take one sheet and see the ads and will eliminate waste since it will not cause people taking more then necessary. Shown in FIG. 3 is the paper towel roll 301, a cylindrical cardboard insert 302, individual sheets of paper towel 303, and perforations 107 which separate the sheets.

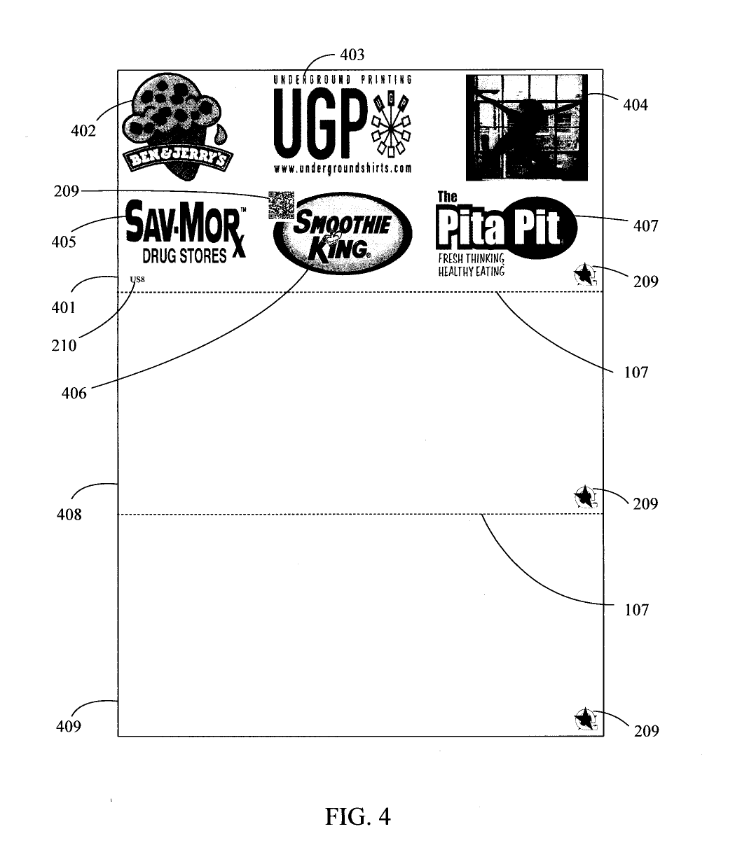

FIG. 4 is a front view of advertising and coupons on a paper towel sheet. Advertisements can be printed in a variety of styles and numbers for all paper towels (as well as toilet paper). A first sheet 401 is imprinted with a first advertisement 402, a second advertisement 403, a third advertisement 404, a fourth advertisement 405 which includes coupon code 210, a fifth advertisement 406 which includes QR code 209, and a sixth advertisement 407. A second sheet 408 and a third sheet 409 are also shown without advertising. The sheets are sectioned from each other with perforations 107. In the bottom right corner of each sheet is a logo 209 representing Star Toilet Paper or a third party company/manufacturer. In one embodiment, one or more advertisements is imprinted on each sheet, the sheets are arranged into groups of sheets, the groups are functionally connected in series, with a plurality of groups comprising an entire roll. In another embodiment the paper towels do not have perforations.

In another embodiment, every sheet on a roll will contain the same number of ads and the same companies. This is to help eliminate waste so people are not using all the paper towels solely to find great discounts and coupons.

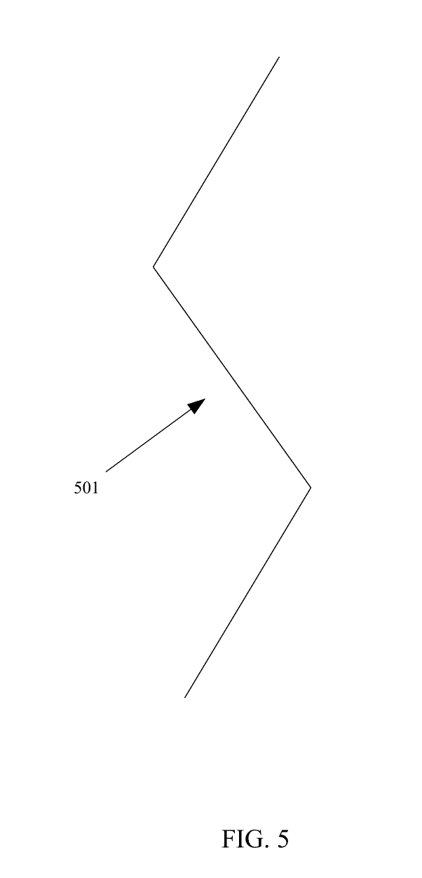

FIG. 5 is a side view of a tri-fold paper towel sheet 501. These are the sheets that are pulled down and out, like an upside down tissue box.

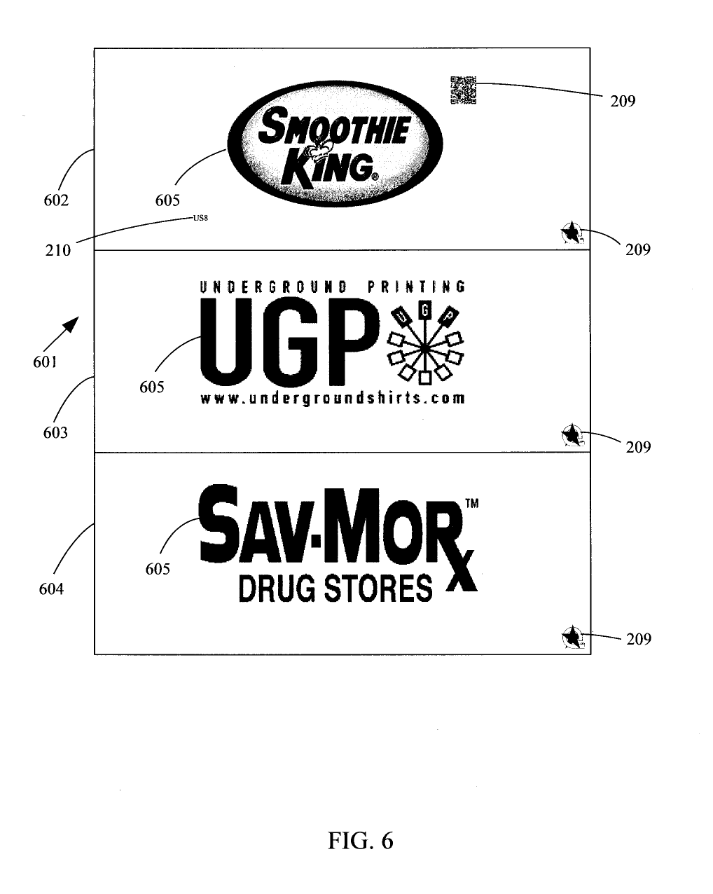

FIG. 6 is a front view of advertising and coupons on a tri-fold paper towel sheet. The tri-fold sheet has a front side 601, back side (not shown), top section 602 which includes QR code 209 and coupon code 210, middle section 603, and bottom section 604. Sample advertisements 605 are shown in each section. In the bottom right corner of each section is a logo 209 representing Star Toilet Paper.

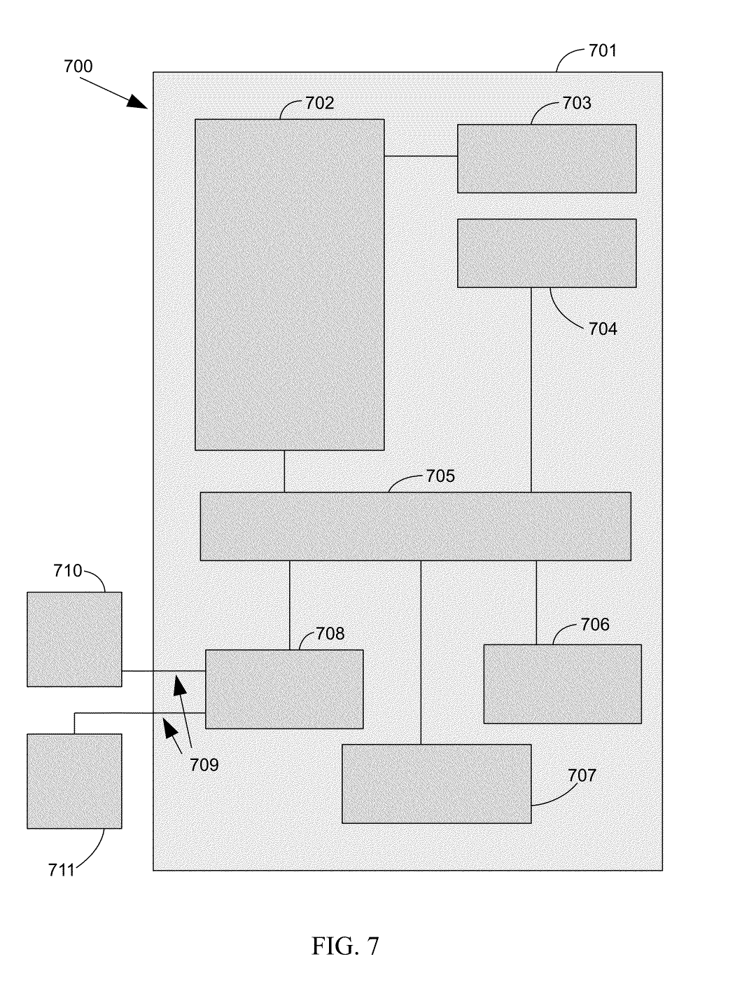

FIG. 7 is a block diagram of a typical computing environment used for implementing embodiments of the present disclosure. FIG. 7 shows a computing environment 700, which can include but is not limited to, a housing 701, processing unit 702, volatile memory 703, non-volatile memory 704, a bus 705, removable storage 706, non-removable storage 707, a network interface 708, ports 709, a user input device 710, and a user output device 711.

Various embodiments of the present subject matter can be implemented in software, which may be run in the environment shown in FIG. 7 or in any other suitable computing environment. The embodiments of the present subject matter are operable in a number of general-purpose or special-purpose computing environments. Some computing environments include personal computers, server computers, hand-held devices (including, but not limited to, telephones and personal digital assistants (PDAs) of all types, iPods, and iPads), laptop devices, tablet devices, multi-processors, microprocessors, set-top boxes, programmable consumer electronics, network computers, minicomputers, mainframe computers, distributed computing environments, and the like to execute code stored on a computer readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

A general computing device, in the form of a computer, may include a processor, memory, removable storage, non-removable storage, bus, and a network interface.

A computer may include or have access to a computing environment that includes one or more user input modules, one or more user output modules, and one or more communication connections such as a network interface card or a USB connection. The one or more output devices can be a display device of a computer, computer monitor, TV screen, plasma display, LCD display, display on a digitizer, display on an electronic tablet, and the like. The computer may operate in a networked environment using the communication connection to connect one or more remote computers. A remote computer may include a personal computer, server, router, network PC, a peer device or other network node, and/or the like. The communication connection may include a Local Area Network (LAN), a Wide Area Network (WAN), and/or other networks.

Memory may include volatile memory and non-volatile memory. A variety of computer-readable media may be stored in and accessed from the memory elements of a computer, such as volatile memory and non-volatile memory, removable storage and non-removable storage. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, memory sticks, and the like. Memory elements may also include chemical storage, biological storage, and other types of data storage.

“Processor” or “processing unit” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, an explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc. for performing tasks, or defining abstract data types or low-level hardware contexts.

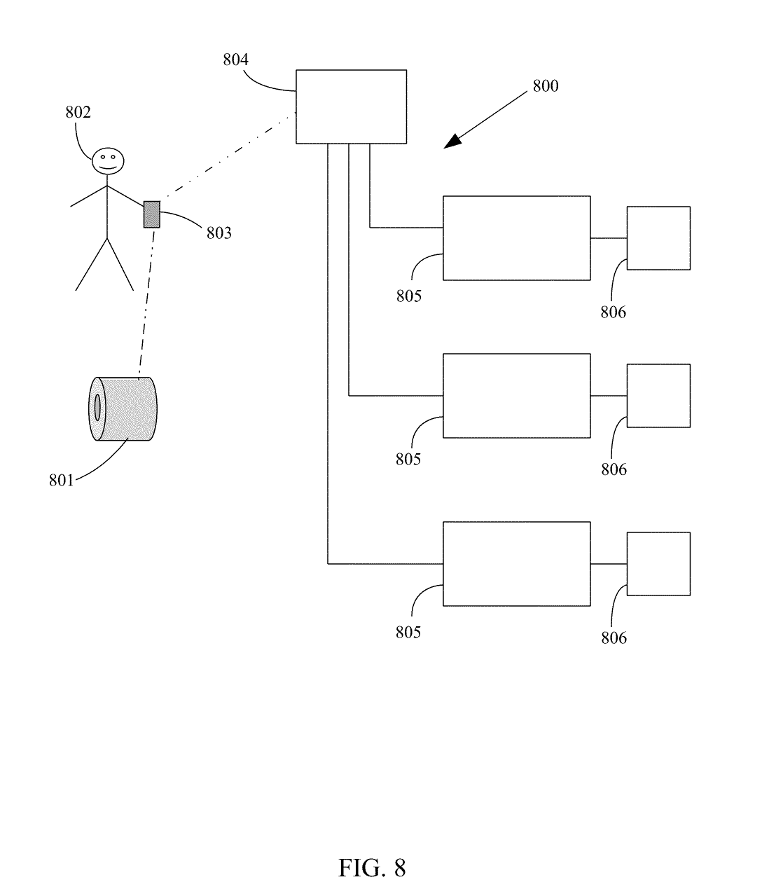

FIG. 8 is a network diagram of a system which can redeem coupon codes, QR codes, or the like. Shown are the coupon code or QR network 800, a paper product roll with a coupon code or QR code imprinted 801, a user 802, a computing environment 803 configured to read a coupon code or QR code and communicate with another computing environment, a computing environment known as a server 804 configured to communicate with computing environment 803, and a plurality of computing environments 805 configured to share data server 804, wherein the plurality of computing environments 805 are each configured to provide data to individual advertisers 806.

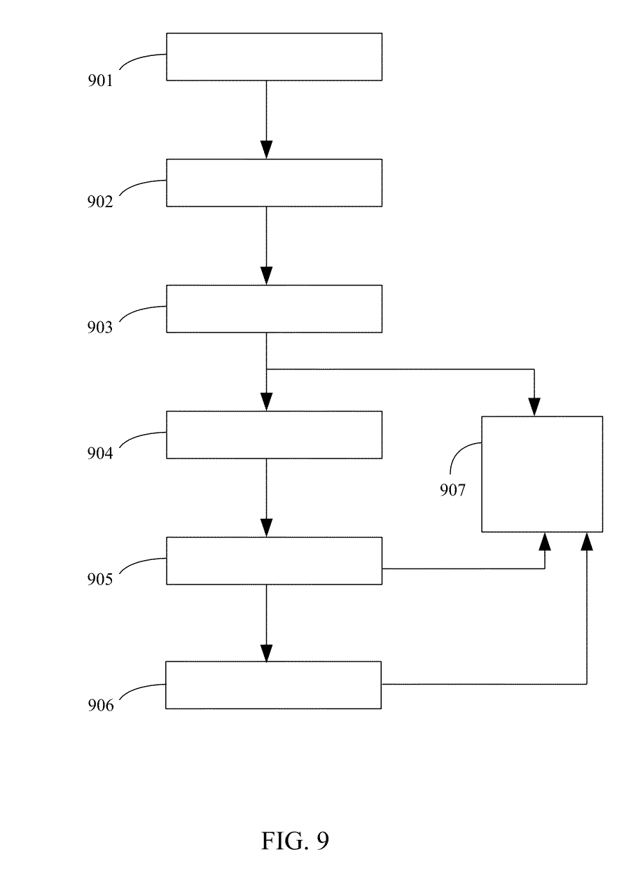

FIG. 9 shows a method for redeeming a coupon code. Step 901, a user enters the bathroom stall and reads the toilet paper. Step 902, the user locates a unique coupon code on the piece of toilet paper. Step 903, the user uses a mobile computing environment to access www.startoiletpaper.com via the internet. Step 904, the user enters the coupon code to be redeemed. In a separate embodiment, the Step 903 and Step 904 could be implemented using an advertiser's or third party website instead of www.startoiletpaper.com. Step 905, the user is able to print, save, or share the image (ad/coupon) on their mobile computing environment. Step 906, the user takes the coupon (printed, on toilet paper, on cell phone, or in another form) to an advertiser and redeems the coupon. This step can take place in person, over the phone, online, or in another form dictated by the advertiser. Step 907, a back-end company, in this embodiment Star Toilet Paper, is able to track the coupon code and determine how many times it is printed, saved, shared, and how many times it is redeemed. This step can be done in another embodiment by a third party company, an advertiser, or someone else. The provider also has the ability to limit the amounts of downloads (Step 905) through IP Blocks, and employ similar limitations (one per user written on coupon, etc.).

Coupon codes, which comprise promotional codes and discount codes, are commonly used in daily transactions. For example, popular online retailers and grocery stores often provide electronic coupons, mailings, and freestanding inserts for their respective companies and clients. Upon entry of a coupon code into an electric cart or presentation of a coupon in person, a discount is applied to a transaction. A similar process can be used with coupons on paper product rolls, where a promotional code can be entered into a mobile computing environment or presented in person. A coupon found on the paper product roll can be redeemed for a discount as a dollar amount, a percentage of the purchase discounted, or the like.

Coupon codes are effective marketing tools, and many consumers are attracted by the savings and other opportunities made possible with these codes. Many known coupon codes may not be well suited for efficient distribution to customers and other recipients. The two-step method described below allows for this distribution to be done efficiently and in a manner that consumers will find useful and entertaining Companies advertising on paper product rolls will have the back-end metrics and measurements of ROI, redemption rate, downloads, etc. via the process displayed in FIG. 9, which many forms of coupon distribution are not able to measure. The data generated by the retrieval and redemption of the coupon codes can be used to develop or revise marketing and strategies to more effectively provide consumers with targeted products and services.

In addition, coupon codes of the present disclosure can effectively establish or enhance a tangible connection between a business and a consumer. In one embodiment, the method includes storing a coupon code on a tangible storing medium of a host computer, receiving a request for the coupon code from the recipient, and providing the recipient with the coupon code via a paper product roll. The coupon codes will be imprinted on the paper product roll using unique letter and number schemes for each coupon. When the coupon code is typed into a mobile computing environment it is automatically recognized from being stored in the host computer. The coupon code can include a redemption limit identifier that limits the number of times the coupon code may be used, a redemption location identifier that designates a redemption location at which the coupon code may be redeemed, a redemption expiration date that indicates a date beyond which the coupon code is not redeemable, or the like.

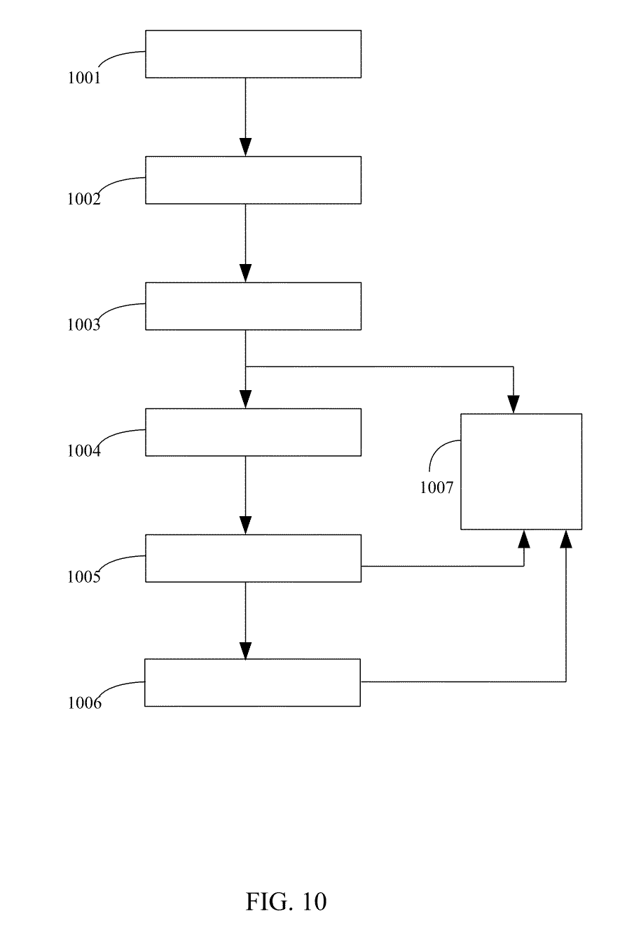

FIG. 10 shows a method for redeeming a QR code. Step 1001, a user enters the bathroom stall and reads the toilet paper. Step 1002, the user locates a unique QR code on the piece of toilet paper. Step 1003, the user enables a mobile computing environment to scan QR codes. Step 1004, the user scans the QR code with the mobile computing environment. When the QR code is scanned, the user will be on a landing page, on the coupon, or on another page that will enable them to use the coupon. Step 1005, the user is able to download, email, save, share, and use the coupon. Step 1006, the user is then able to present the coupon to an advertiser and redeem it. Redemption can be done by simply looking at it on the user's computing environment, can be required to be brought in printed out, can require a signature, can be scanned through a barcode, or the like. Step 1007, a back-end company, in this embodiment Star Toilet Paper, is able to track the QR code and determine how many times it is printed, saved, shared, clicked, and how many times it is redeemed. The provider also has the ability to limit the amounts of downloads (Step 1005) through IP Blocks, and employ similar limitations (one per user written on coupon, etc.). Steps 1004, 1005, and 1006 can be tracked by the back-end company/provider.

The above-discussed method referred to in FIG. 10 is for QR codes on a paper product roll to launch coupons and interactive landing pages when scanned with a client device having an optical sensing device or camera. The client devices include mobile and fixed devices and are coupled with a mobile computing environment to enable coupon redemption and tracking The system of an embodiment for supporting QR code recognition processing for coupons and advertisements comprises one or more client devices or clients and a server. Each client of the system comprises a scanner component along with the corresponding or coupled scanning application configured to scan a QR code.

A QR code is a matrix code or two-dimensional bar code. The QR code includes information or indications of a command for a location on the web or a server that the user wishes to access. QR codes can be used for a variety of purposes, including coupon scanning, coupon tracking, and/or coupon redemption by the toilet paper manufacturer, advertiser, or third party company. QR codes will be able to store and play back uniform resource locator (URL) as well as coupons and landing pages.

The user will locate the QR code on a paper product roll and scan the code via a third party application such as Snip Snap or generic QR code scanner applications found on the Application Stores of Apple, Droid, and other mobile computing environments. The third party application sends the QR code data request to the server supporting the QR code processing application and URL from the decoded QR code to the user. The usage of QR codes and a mobile computing environment allows for both instant coupon redemption as well as coupon tracking allowing Star Toilet Paper, or a third party company or application to track ROI, redemption rate, downloads, etc.

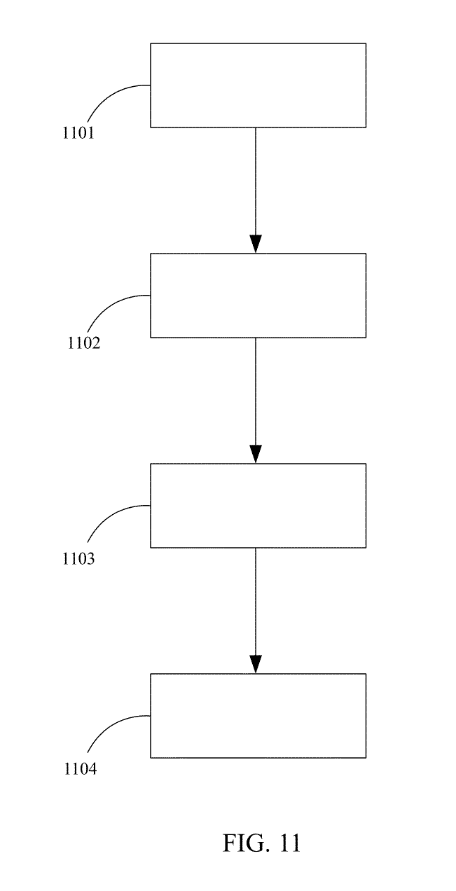

FIG. 11 shows a method for incorporating a third party application into the coupon redemption or instant redemption field. Step 1101, toilet paper is placed in a public venue such as a bar, restaurant, library, apartment building, bowling alley, movie theater, state/public owned building (park, recreation area, state building, etc.), stadium, university, college, airport, rest stop, club, casino, hotel, or the like. Step 1102, a user looks at the toilet paper and decides to redeem a specific coupon. Step 1103, a third party application is used such as QR Code scanner, Snip Snap, Touchcode, or the like. Step 1104, the coupon is redeemed at a store either as a hard copy or via Step 1103.

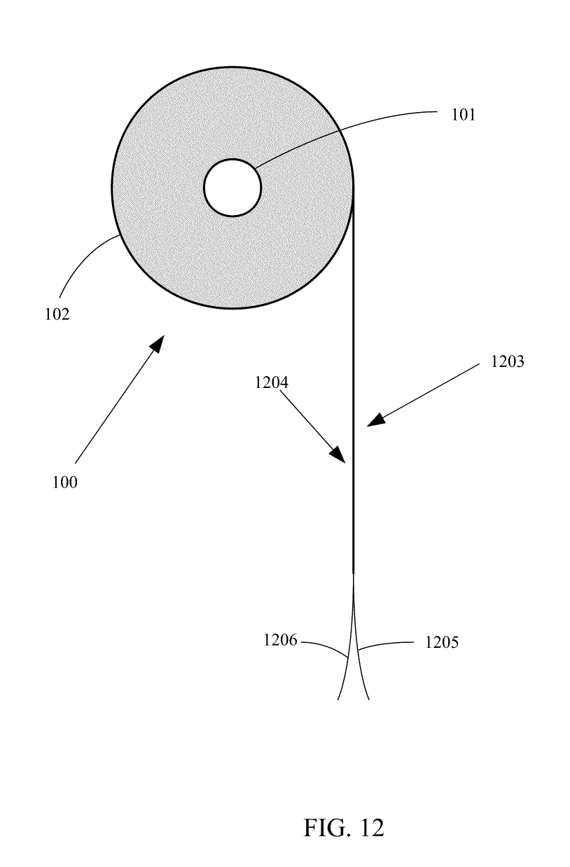

FIG. 12 is a side view of a roll of toilet paper with the end sheet flared to show different plys. Shown are a roll of toilet paper 100, a cylindrical cardboard insert 101 on which the toilet paper 102 is rolled around, top side of toilet paper 1203, bottom side of toilet paper 1204, top ply 1205, and bottom ply 1206.

The primary method of redemption will be through coupon codes, QR Codes, and other instant coupon downloads. A method for using a coupon code comprises: having a user locate a code on a paper product roll, and typing the code into a coupon code redeemer which is coupled to a website. For a QR code they are able to locate the code and scan it on their mobile phone with a third party application. Once it is scanned they will be able to download, share, and redeem the coupon. In another embodiment, other instant coupon and advertisement redemption models such as third party applications can be used. A user will be able to download a coupon onto a mobile computing environment to email and save. Social media buttons such as Facebook™ and Twitter™ will be made available to share the coupon. The coupon will be used by either owner/employee signature at the store or simply showing the downloaded coupon on one's mobile phone, by barcode scan, or in hard copy.

Through the usage of a two-step process the end goal of supplying users highly targeted and useful coupons will be achieved. The first step is to acquire a venue to carry the printed toilet paper. A venue is considered any public place that has a bathroom available to the public. At this point only venues with public bathrooms will be targeted (bar, bowling alley, stadium, university, etc.), however reserved is the right to enter the consumer and private sector of toilet paper. The second step in the process is obtaining advertisers. This two-step process ensures success for venues, advertisers, and consumers.

The advantages of the present invention include, without limitation, that it has the ability to reach a more specific demographic than most other forms of advertising. It can be focused to certain geographic areas, and being that males and females use different bathrooms, it will make selective advertising easier. It is easy to envision a future where advertisements are placed directly on bathroom tissue being that advertising is in almost every other sector of life. It is also beneficial for venues that carry the printed toilet paper, because they will receive the toilet paper for a reduced price. Star Toilet Paper, another related subsidiary, or company are able to do this by using the revenue brought in by advertisers.

While the disclosure describes embodiments and various alternatives thereto, it should be apparent that the invention is not limited to such embodiments. Rather, many variations would be apparent to persons of skill in the art without departing from the scope and spirit of the invention.

For the purpose of this disclosure, to imprint comprises: to apply indicia onto or into a medium, such as paper, using pressure or other means (e.g. lithographic, electrostatic, or the like).

For the purpose of this disclosure, a mobile computing environment comprises any computing environment, computer, laptop, mobile phone, smart phone, PDA, tablet, or anything similar utilizing Wi-fi, 3G, 4G, or the like enabling wireless internet connection and the interaction amongst any of these with each other or combined with users.

We claim:

1. A paper product roll configured for advertising, the paper product roll comprising: toilet paper or paper towel imprinted with advertisements and/or coupons.

2. The paper product roll of claim 1, wherein the advertising is configured to enable on-line coupon redemption, instant coupon redemption, or advertisement tracking

3. The paper product roll of claim 2, wherein the tracking will be done via QR Codes, coupon codes, bar codes, and anything utilizing a third party application or mobile computing environment combined with instant redemption.

4. The paper product roll of claim 2, wherein the toilet paper or paper towel further comprises a top ply and a bottom ply, and the advertising is imprinted on the outside surface of the top ply.

5. The paper product roll of claim 2, wherein the toilet paper or paper towel further comprises a top ply and a bottom ply, and the advertising is imprinted on the outside surface of the bottom ply.

6. The paper product roll of claim 2, wherein the toilet paper or paper towel further comprises a single ply, and the advertising is imprinted on either top or bottom of the single ply.

7. The paper product roll of claim 2, wherein the advertising further comprises advertising groups, each group consisting of a plurality of advertisements or coupons, and the groups are functionally attached in series.

8. The paper product roll of claim 2, wherein the advertisements and/or coupons consist of soybean-based ink.

9. The paper product roll of claim 2, wherein the advertisements and/or coupons include copyrighted or trademarked images.

10. A method of using a paper product roll configured for advertising, the method comprising: reading toilet paper or paper towel imprinted with advertisements and/or coupons, wherein the advertising is configured to enable on-line coupon redemption or advertisement tracking;
locating a unique coupon code on the toilet paper or paper towel;
entering the unique coupon code into a mobile computing environment; and
accessing a remote server wirelessly to transfer the unique coupon code to the remote server, wherein the remote server is configured to save unique coupon code usage and location data to a server memory.

11. A method of using a paper product roll configured for advertising, the method comprising: reading toilet paper or paper towel imprinted with advertisements and/or coupons, wherein the advertising is configured to enable QR code redemption or advertisement tracking;
locating a QR code on the toilet paper or paper towel;
scanning the QR code with a mobile computing environment; and
accessing a remote server wirelessly to transfer the QR code to the remote server, wherein the remote server is configured to save QR code usage and location data to a server memory.
